(19) United States
(12) Patent Application Publication
(10) Pub. No.: US 2012/0242492 A1
(43) Pub. Date: Sep. 27, 2012

(54) SEAT OCCUPANCY DETECTION AND DISPLAY SYSTEM

(75) Inventor: Pinchas GRUNFELD, Haverstraw, NY (US)

(73) Assignee: Tov 1 LLC

(21) Appl. No.: 13/071,664

(22) Filed: Mar. 25, 2011

(51) Int. Cl. G08B 21/00

(52) U.S. Cl. 340/667

(57) ABSTRACT

A seat occupancy display system which includes a seat occupancy sensor array with individual sensors. Each sensor is configured to detect the weight bearing thereon and to output an occupancy signal. Individual sensors can be configured to provide a location identification thereof. An interface circuit communicates the occupancy signals to a central processor which is configured to create a data file representative of the seat occupancies in the seating arena. A display coupled to the central processor is configured to display either a list of occupied seats and/or a map of the seats with an indication of which seats are not occupied. Also, orders for refreshments or other items can be ordered at each seat and the orders can be transmitted to attendants for real time payment and delivery.

### FIELD OF THE INVENTION

The present invention is generally directed to sensing systems and, more particularly, to a system for sensing the seat occupancy in large seating arenas such as in public theaters, airplanes, large conference halls and the like, which system is also suitable for allowing attendees to order refreshments from their seats.

### BACKGROUND OF THE INVENTION

Quite frequently movie goers arrive at a movie theater to find that the movie has already begun with the lights having already been turned off or dimmed close to utter darkness. They are left with the unpleasant experience of groping their way in the dark peering intently to find unoccupied seats. All the while, their lingering activities pose a disruption and inconvenience to the other, already seated moviegoers.

In the same vein, people arrive late to large conference halls where a lecture may already be ongoing and, standing from afar, try to locate empty seats. Their activities are sometimes personally embarrassing to them and certainly inconvenient and disruptive to others. A similar situation occurs quite often in airplanes where the flight attendants need to ascertain that the full complement of passengers is actually seated with the seatbelts fastened.

U.S. Patent Application No. 2010/0253504 discloses a personal monitoring system that can work wirelessly to monitor people. Each person is initially positioned near a person support device coupled with a respective presence determining device that determines the presence of the person. Thereby, the presence or absence of one or more persons associated with the system can be known.

### SUMMARY OF THE INVENTION

One general object of the invention is to provide a system that avoids the aforementioned drawbacks of the prior art.

Another object of the present invention is to provide a system that easily and inexpensively senses the seat occupancy in large seating areas, such as in theaters, airplanes, and large conference halls.

It is yet another object of the invention to provide a system that produces a seating display map which can immediately inform a late arriving person where the empty seats are located and thereby allow that latecomer to quickly proceed to the unoccupied seat of her/his choice.

It is yet another object of the invention to provide a system that can provide a reporting function to apprise a manager or a manager's assistant, how many people have attended a particular gathering, and how long they have remained in their seats, etc.

In accordance with the invention, each seat of a movie theater, concert hall, auditorium, bus, ship, airplane or the like is equipped with an occupancy sensor to detect whether the seat is being occupied and to transmit the signal accordingly to a central processor or computer system, which can be a CPU, a controller or the like.

Seat occupancy can be accomplished in two main embodiments. According to one embodiment, the seat contains only a passive switch contact which is activated by the weight of a person on the seat. The switch signals/outputs from each sensor are routed through individual wires to an array of parallel and stacked multiplexers, reach to the central processor CPU, and thus sensed for determining seat occupancy. Another approach is that each seat is outfitted with an intelligent IC chip circuit that detects the state of the local sensor to determine that the seat is occupied and is able to communicate the seat number and the occupied/non-occupied status through a serial bus or even wirelessly to the central processor.

If the intelligent IC chip embodiment is provided at each seat, the location of the seat may be stored in the IC chip in hard or writable memory. Alternatively, the seat identification can be stored, with the local IC chip determining whether the seat is occupied and reporting by wireless or wired connections to the central computer both the occupancy state and the seat I.D. In an airplane embodiment, the status of the seatbelt can also be reported. The occupancy sensor may be a contact strip or ribbon, or a piezoelectric device or a similar device which outputs an electrical output indicative that the weight of the person is bearing on the sensor.

To avoid spurious responses, a seat may be declared occupied only after the occupancy condition has been verified at least 10 times over a 3 or 4-minute interval. The processor can also provide a count and optionally a duration of occupancy, for historical or reporting purposes.

The central processor can provide a reporting function about seat occupancy and vacancy for each seat and statistical information, such as percentage of seats occupied, for any given show or performance. The central processor also provides real time occupancy information to a display, which is typically positioned outside of the auditorium so that latecomers can consult it and know, based on the display, where empty seats are located. The display can be a special display board containing a matrix of LEDs, and located outside the hall and showing the locations of unoccupied seats, either by lighting up LEDs corresponding to unoccupied seats or by using a color scheme, e.g. red representing occupied, and green representing an unoccupied seat etc. Alternatively, the display can be an ordinary flat monitor display or a flat television screen showing a map of the seats layout and the occupancy status thereof using either symbols, or a color scheme or text, in steady or blinking characters and the like.

Also contemplated is an amenities or services or refreshments ordering system that allows seated persons or audience members to order food or beverages, merchandise or the like from the seat using an input apparatus, such as a keypad, trackpad or touch screen, and a payment apparatus, such as a credit or a debit card swiper or smartcard sensor or the like, located at the armrest or at a back of the seat immediately in front of the seat of the ordering person. Employees of the movie theater or sports arena, for example agents or attendants at the concession stand, would be notified immediately of the order placed at the seat and would be able to locate the seat immediately using the display system so that the food is conveniently and quickly delivered without undue disturbance of nearby members of the audience.

The display can also be provided at a concession stand so that attendants know that amenities ordering has been made so that refreshments or other items or services can be delivered in a convenient manner without burdening nearby attendees. The central computer can also provide real time occupancy information via, for example, an internet connection, to an off-site location, for example to verify the number of seats occupied during any given show or performance. In this way, management can check the number of tickets sold against the number of seats occupied so as to detect abuse or fraud on the part of the ticket agent at the box office or on the part of attendees who sneak in to a show or performance without purchasing a ticket.

Other features and advantages of the present invention will become apparent from the following description of the invention which refers to the accompanying drawings.

### BRIEF DESCRIPTION OF THE DRAWINGS

FIG. 1 is a system block diagram of an embodiment of the present invention.

FIG. 2 is a schematic illustration of a seat layout, and a seat occupancy sensor distribution chart according to the present invention.

FIG. 3 is a seat occupancy display, according to an embodiment of the present invention.

FIG. 4 shows a strip or ribbon shaped seat occupancy sensor, according to an embodiment of the present invention.

FIG. 4a shows internal details of the sensor of FIG. 4.

FIG. 4b shows a seatbelt engagement sensor.

FIG. 5 is a schematic illustration of an intelligent seat occupancy sensor device, according to an embodiment of the present invention.

FIG. 6 is a circuit block diagram for an MUX based sensor connection scheme, according to an embodiment of the present invention.

### DETAILED DESCRIPTION

As noted above, the present disclosure is directed to a system for sensing the seat occupancy in large seating arenas, such as in public theaters, airplanes, large conference halls and the like.

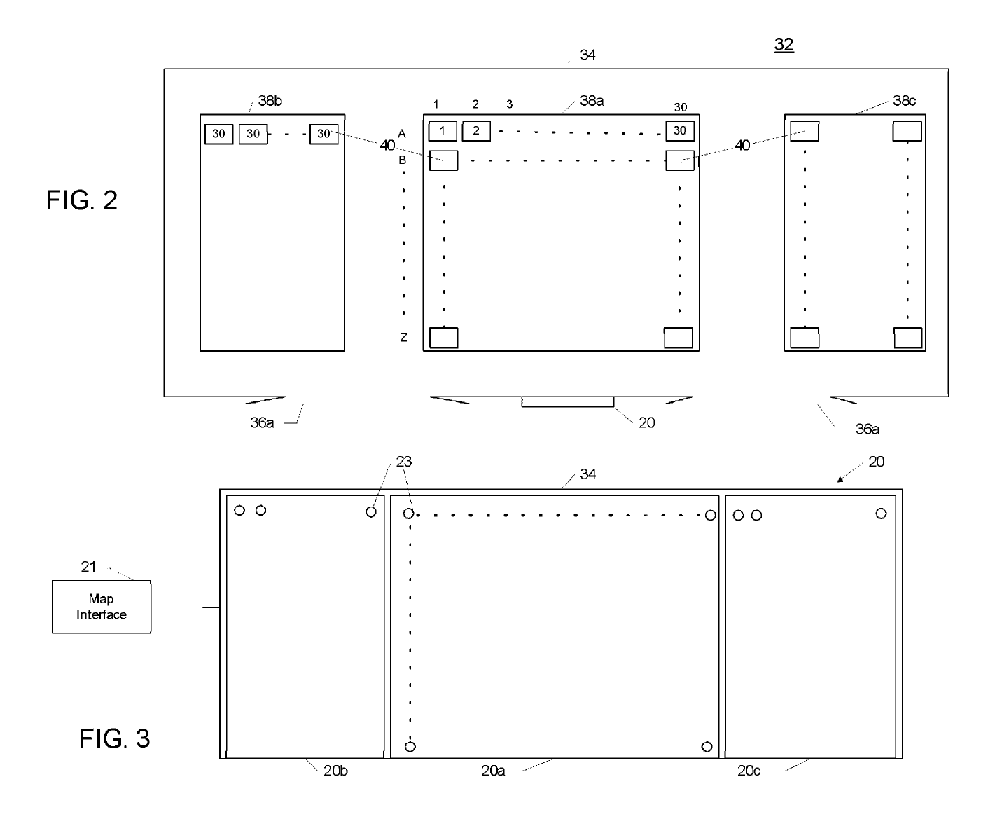

FIG. 2 shows typical arena such as a theater 32 having a surrounding wall 34, with a central seating section 38a, a left side seating section 38b and a right side seating section 38c. Between these seating sections are walking halls which face respective doors 36a and 36b. Each seating area has a plurality of seats 40 which are arranged in rows and columns. For example, in the central seating section 38a, the rows are identified with the letters A, B, . . . Z and the seats in each row by numerics 1 through 30.

The overall objective is to provide a display 20, which would typically be hung on the wall 34, outside of the movie theater and on which there would be displayed a map showing the seats that are unoccupied (and/or occupied). An example of such a display 20 is shown in FIG. 3, which shows the display 20 having three sections corresponding to the seating sections in FIG. 2, with indicator lights, typically LEDs 23, which would either be colored red or green or just blink to indicate the unoccupied seats. Thus, the display section 20a corresponds to the seating area 38a, the section 20b to the seating area 38b and the section 20c to the seating area 38c. The LEDs 23 are lit by receiving signals from a map interface 21 which, as shall be described, is connected to a central processing system that provides the appropriate drive signals for the LEDs 23.

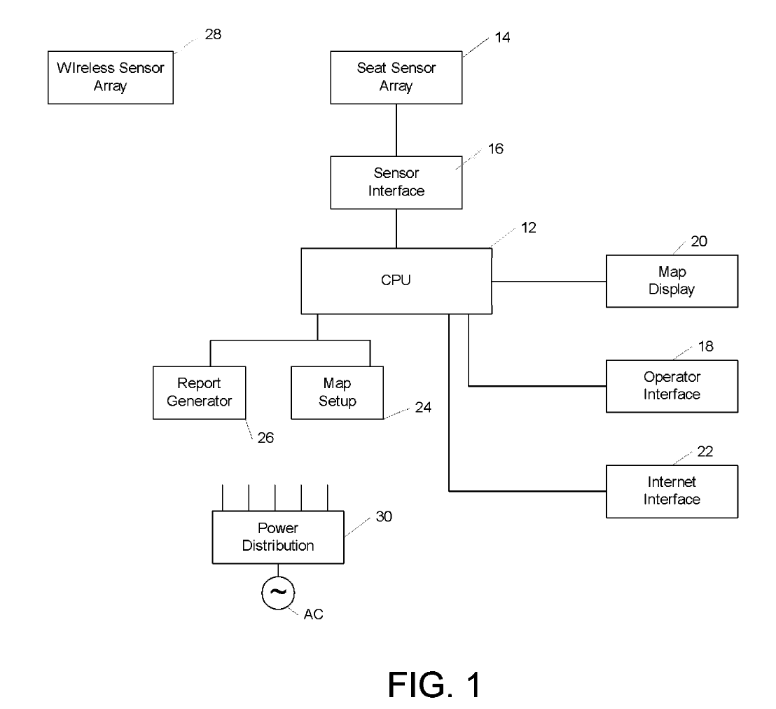

Referring now to FIG. 1, in a typical layout, a CPU or a central controller 12, including the typical complement of RAM, ROM, hard disc and other memory runs a software program that controls the overall operation, including the interfacing to a seat sensor array 14 which provides occupancy signals to the CPU 12, via a sensor interface 16.

The CPU 12 also interfaces with the aforementioned map display 20 and displays thereon the seat occupancy information. As noted previously, the display 20 can be provided as a simple flat, television style monitor and the signals provided to the map display 26 via the map interface 21 can be in the form of NTSC or similar television signals or monitor signals, effective to display any information on said display. The seat occupancy information can be in the form of written alphanumeric characters. For example, if the seat B12 in the central seating section 38a is vacant, at that location would appear the indication B12, informing the user to proceed to row B, seat 12, which is unoccupied.

The CPU 12 is also coupled to an operator interface 18 which provides a keyboard or the like for controlling the CPU 12 and also for initial programming of the map display 20, including the location of the sensors associated with the seat sensor array as shall be described. Internet Interface 22 similarly interfaces with the CPU 12 and can provide information about seat occupancy, including historic information and other similar information, to a remote location. The blocks Map Setup 24 and Report Generator 26 indicate or represent software modules responsible for the initial map set up information and organization. The Report Generator can be tailored to produce specific and/or periodic reports requested by different operators of the system. In an airplane setting, the CPU can reconcile seat occupancy information against the passenger flight data, informing flight attendants who is not at their seat and/or seat belted. This can speed up plane (or train) embarking and disembarking.

In FIG. 1, the seat sensor array 14 represents physical seat occupancy sensors which are connected by a physical wiring network to the sensor interface 16, which, as will be described, is hardwired to the CPU 12.

The alternative to the hardwire arrangement is to provide individual sensors at each seat which operate wirelessly and thus provide a wireless sensor array 28, which communicates wirelessly to the CPU 12 as indicated by the dashed lines in FIG. 1.

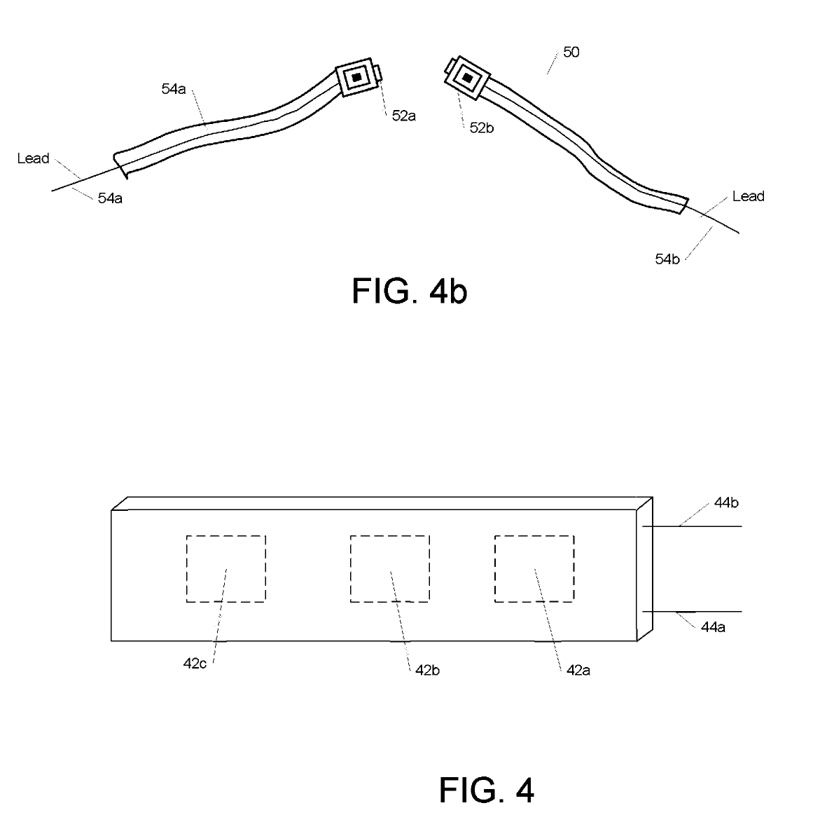

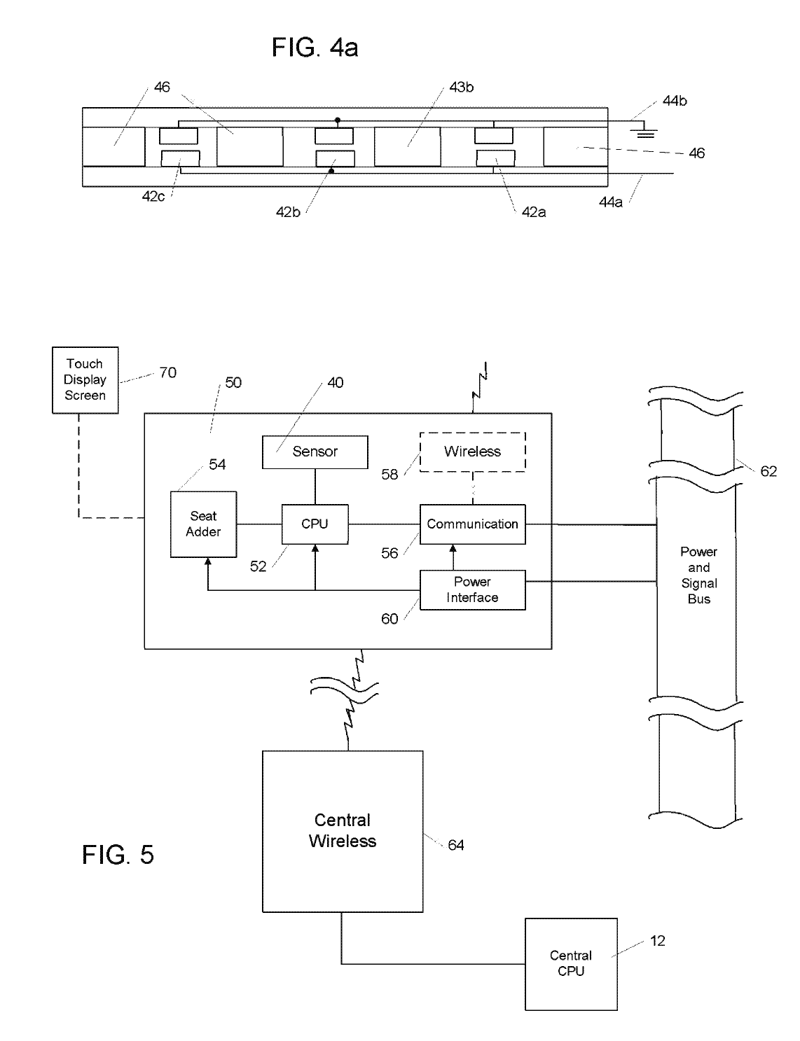

An individual seat occupancy sensor can be implemented in the form of a strip shaped flexible ribbon 40 which is illustrated in FIGS. 4 and 4a. The strip body 41 is generally rectangular and is made of several layers with electrical contacts therebetween and with first and second electrical leads 44a and 44b. Within the strips are several electrical contacts 42a, 42b and 42c, whereby when the ribbon body 41 is inserted under the seat upholstery and a person sits on it, an electrical circuit is completed between the leads 44a and 44b. In FIG. 4a, each electrical contact is made of upper electrical contacts connected to the lead 44b and lower electrical contacts, which are separated by a very small gap from the upper electrical contacts, which are all connected to the second lead 44a. In use, all of the upper electrical contacts are connected to ground. The ribbon has an upper layer and a lower layer which are separated by resilient bodies 46, which are interspersed throughout and keep the electrical contacts apart. However, under a weight of, say, more than 25 or 40 pounds, representing a human being, the resilient bodies 46 compress, allowing contact being made at any one of the electrodes 42a, 42b or 42c, completing the circuit and indicating a seat occupancy at lead 44a which become connected to ground.

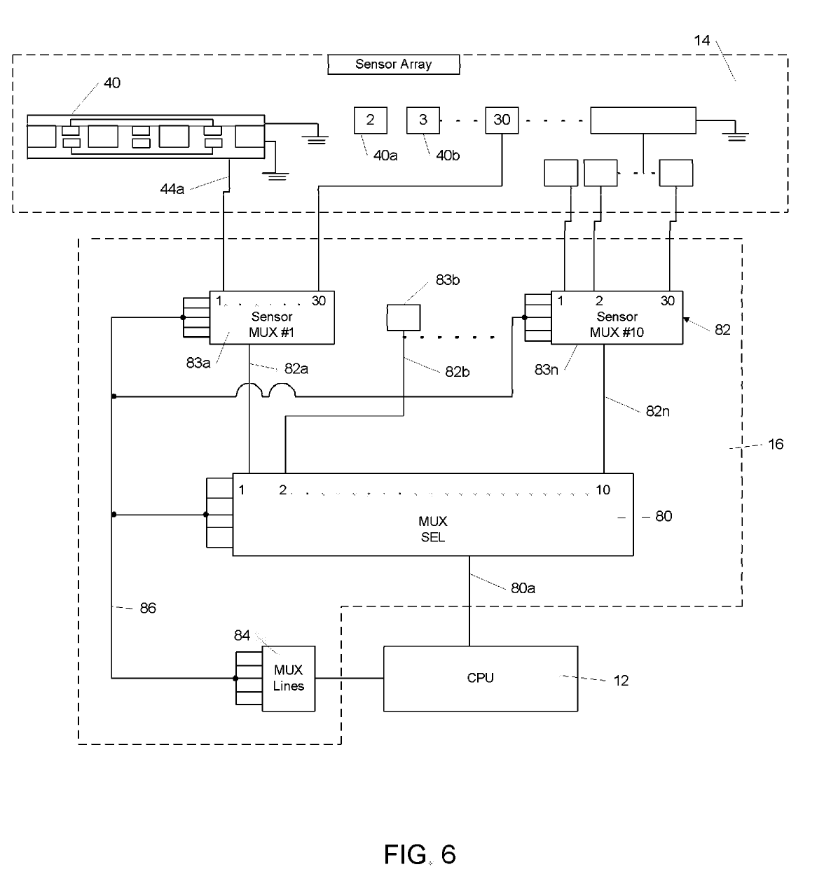

Referring now to FIG. 6, the sensor array 14, comprising the individual sensor ribbons 40, 40a, 40b, and so on, distributed throughout a theater, an airplane, or any seating arena, can be interfaced such that the respective occupancy signal wire 44a and so on, from each of sensors 40 is interfaced to the CPU 12 via the aforementioned sensor interface 16. Sensor interface 16 can have, in accordance with one embodiment thereof, a plurality of multiplexer devices, including a main MUX 80 which selects from among groups of different seat sensors one particular sensor group, which is supplied to the CPU 12 through its output line 80a. The main MUX 80 selects from among 10 output lines 82a, 82b . . . 82n, associated respectively with a respective one of frontline multiplexers 83a, 83b . . . 83n. Each of the frontline MUXes 83a, 83b . . . 83n is connected to a group of about 30 sensors. Thus, when the CPU 12 outputs to its output MUX line 84, an address field 86 consisting of a predetermined number of bits which are provided to each of the aforementioned MUXes, the sensor output for a particular seat is read by the CPU 12. For example, for an address line consisting of all zeros, the first input 44a into the first MUX 83a is selected, which is then also selected by the main MUX 80 and presented to the CPU 12. Increasing the address by 1 enables testing the state of the next seat, and so on through the many different groups of seats of 30, in well known manner. At the operating speed of CPUs, in less than a millisecond, the occupancy state of all of the seats can be easily looked at. In typical operation, the occupancy state would be checked, for example, repetitively over a half minute, to ensure that no signal noise, etc. might provide a false occupancy indication. This information is then collated and correlated by the computer to output its seat occupancy state for the map display 20 or for providing a report via the Internet or to a display at an operator's screen.

The power distribution block 30 shown in FIG. 1, is utilized to convert A/C power so as to provide low voltage power for all of the electrical circuits described herein.

In accordance with an alternate embodiment, each seat is provided with its own smart sensor 50, which is a small electronic subsystem as illustrated in FIG. 5. That smart sensor 50 includes the physical sensor 40 described above, or possibly a wireless sensor connected thereto, with a local CPU 52 that is programmed with the seat address 54 at which it is located and also includes a power interface 60 and a communication port 56. Through the communication port 56, the occupancy state of the particular seat can be communicated via a two line (or only a few lines) wiring system, for example, over the power and signal bus 62, to thus reach the central CPU 12, by time division multiplexing. Alternatively, the state of the signal can be communicate wirelessly from the wireless interface 58 and received by a receiving central wireless interface 64 associated with a central CPU 12. This embodiment, shown in FIG. 5, adds cost to the sensing system at each seat, but avoids the need for extensive wiring of an arena, such as a theater.

The device 70 is associated with and comprises an amenities ordering system. In FIG. 5 it is shown attached to the unit 50 and of being in communication with its CPU 52. In typical application, the device 70 may be positioned in the armrest or in a support attached in front of each seat or in any location accessible to the occupant of the particular seat. It typically provides either a keyboard or a touchpad (not shown) on which one can enter an order for various products, which may be typically food, and being provided with a status on an associated display as to when the order would be ready. It is inherent that the amenities ordering system 70 automatically identifies to the central CPU 12 the location of the person submitting the order. The system 70 can include a reader (not shown) for reading a credit or debit card or the like. The display can provide a menu of products that are available. Upon ordering any product, the product would be delivered to the seat by an attendant who would know the exact seat and so very rapidly, and unobtrusively, deliver the order.

As noted above, the contact sensor 40 may be provided as a ribbon or strip positioned in the upholstery, attached to the seat cushion, or the like.

Alternatively, a radio frequency ID tag (RF ID tag) with a unique code can be provided at each strip sensor such that the RF ID tag is enabled when sufficient weight is applied to the seat and a local reader, for example a reader integrated with the armrest or positioned on top of the armrest of the seat or may be provided at various other locations throughout the auditorium. The reader may also be integrated with the amenities ordering system 70. The local reader may periodically pole wirelessly the tag and the determination that the seat is occupied may be made when the RF ID tag is activated, enabled by contact of the opposing electrical contacts. Polling can take place several times per second, for example three times, to avoid spurious signals. Polling may be initiated at set periods, for example every few minutes. The seat occupancy detection can be done wirelessly or by a polling scheme with each device having a unique address, which is set via switches or via E-RAM. The individual switches or contacts can be programmed wirelessly or pre-programmed. The communication about seat occupancy can be over a bus line or the power line. Power can be provided individually or the devices battery operated.

Other types of seat sensors instead of or in addition to the sensor strip 50 are also contemplated. Such other sensors may include a sensor that senses when a seat is in a folded up position and/or senses when the seat is in the folded down position, and a light sensor, for example provided as a light sensing diode, that detects whether light from an opposingly positioned light, such as an LED, is blocked by a presence of an attendee on the seat or detects that light is able to reach it.

The ordering device 70, as noted, includes buttons that may include a keypad for ordering various types of amenities, refreshments, food, beverages or merchandise. The local display can then show to the attendee at the seat various types of merchandise selected using number codes provided at ordering unit 70 and confirm the order made or the purchase made or the purchase amount or the like to the seated user. It will be understood that such an amenities ordering system 70 can be shared by more than one seat, for example, each pair of seats can share one amenities ordering system. The ordering device 70 may include a trackpad, in addition to or instead of the keypad to enable interaction between the user and the unit, and a trackpad or other types of user interfaces may be provided as well. In addition, the ordering device 70 may include a local LCD display or other monitor that shows the options of merchandise or amenities or services available for ordering, allows the user at the seat to make the merchandise selection and payment method selection by pressing directly on the screen or monitor, i.e. on the touch-sensitive display, and to confirm to the user what items have been ordered, credit card or debit card status, cost and other payment information or the like.

A credit card reader may be also included in the ordering system 70 to allow the user to make payment for the items purchased or services purchased immediately at the time of ordering. A credit card reader may also be configured to read debit cards or special created cards unique to the auditorium or theater with a pre-set value. Although shown as a credit/debit card reader, reader 70 may also be used to read smartcards or the like.

The seat occupancy and display system described above has particular useful application with regard to school buses. The various sensors would be installed in the seats of the school bus and the display would be located near the driver. Thus, when a driver completes his run, depositing the children, the display would be consulted to ensure that no child has been left sitting or sleeping on any seat. Note that as described before, the CPU 12 in the school bus application, is also configured to transmit the school bus seat occupancy information wirelessly to another location, for example, school authorities. As another option in the context of a school bus application, an alarm would sound whenever any children are left sitting or sleeping on any seat as the engine is turned off. This also requires an engine on signal being coupled to the CPU 12.

In another application, the seat occupancy detection display system of the present invention would be adapted for use in restaurants. In this context, the CPU 12 would also include a module that gauges the length of time that certain seats are occupied, so as to alert management whether a particular party may be lingering too long at their seat, beyond an allowed maximum to optimize usage of the restaurant.

Lastly, in embodiments where seat belt engagement is sensed, the invention also includes the concept of including electrodes in the buckles and that, preferably, the electrodes contact each other electrically when the seat belts are tightened on a person's body, pulling the electrodes into contact.

The inventions described herein are also applicable to trains. Every once in a while it has been heard of a person who is left on a train for several days, having been deceased, and this invention would enable immediate detection of such a circumstance. The same is true of a person who oversleeps on a train or is homeless or inebriated. Another application of the invention is to note the arrival times of patients in doctors' office or in retail businesses, etc. The display would indicate the order in which people have arrived.

Yet another application would be for use by long-haul truckers. The invention can log the number of hours a trucker has been driving. By law, they are required to a break every so often, and the invention can log the driving times and either record it locally, or report it wirelessly to a remote supervisory agency.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A seat occupancy and display system, comprising:
a seat occupancy sensor array including a plurality of individual sensors, each sensor being configured to detect a weight bearing thereon and to output an occupancy signal, said sensor array being configured to being installed in individual seats dispersed over a seating arena;
an interface circuit for receiving the occupancy signals from the individual sensors;
a central processor coupled to the interface circuit and configured to create a data file representative of seat occupancies in said seating arena; and
a display coupled to said central processor and configured to display thereon at least one of a list of unoccupied seats and a map of said seats with indications thereon of which seats are not occupied.

2. The system of claim 1, further including an operator interface configured to allow an operator to exercise control over said central processor.

3. The system of claim 2, including a report generator associated with said central processor to provide reports regarding the seat occupancies.

4. The system of claim 2, including an Internet interface for enabling remote controlling of said central processor and remote displaying of information.

5. The system of claim 1, wherein said individual sensor is constituted as a ribbon with internal, pressure activated electrical contacts.

6. The system of claim 1, wherein said individual sensor comprises a piezoelectric element.

7. The system of claim 1, wherein said interface circuit comprises a multiplexer stack arranged to receive the occupancy signals and to selectively direct said occupancy signals to said central processor.

8. The system of claim 7, wherein said interface circuit communicates said occupancy signals from said individual sensors to said central processor wirelessly.

9. The system of claim 1, wherein said individual sensor at a particular seat in said seating arena comprises a physical occupancy sensor and a local CPU which receives said occupancy signal and which is programmable to store a seat identification in said local processor.

10. The system of claim 9, wherein said local CPU is configured to transmit said local occupancy signal through common electrical lines over which other sensors communicate with said central processor, using time division multiplexing.

11. The system of claim 9, wherein said local CPU is configured to communicate wirelessly with said central processor.

12. The system of claim 1, further including a seatbelt engagement sensor array for sensing an engagement state of a seatbelt associated with respective ones of said seats.

13. The system of claim 12, including a report generating module associated with said central processor and effective for reporting to a central location information identifying non-engaged seatbelts relative to occupied seats.

14. The system of claim 1, wherein said display comprises one of a flat television or monitor screen.

15. The system of claim 1, wherein the display includes LED devices for indicating the occupancy state at the various seats.

16. The system of claim 1, wherein each of the individual sensors comprises a ribbon with embedded opposed but spaced electrical contacts which are separated by resilient bodies, but which are configured to contact each other upon a weight being applied to said ribbon.

17. The system of claim 1, wherein the individual seats are arranged in sections, with each section comprising a plurality of rows of seats.

18. The system of claim 17, where said interface circuit comprises wiring that extends along rows of said individual sensors and additional wiring that extends along columns between seat sections.

19. The system of claim 1, in combination with a school bus, wherein the school said display is mounted adjacent a driver of the school bus and the seat occupancy sensor array are mounted in the seats of the school bus.

20. The system of claim 1, wherein the seating arena is a restaurant.
